(19) United States
(12) Patent Application Publication
(10) Pub. No.: US 2010/0196862 A1
(43) Pub. Date: Aug. 5, 2010

(54) METHOD OF TEACHING A FOREIGN LANGUAGE BY APPLYING AWARENESS AND EMOTIONAL INTELLIGENCE TOOLS

(76) Inventor: Gila FRISCHER, Kiryat Ono (IL)

Correspondence Address: DEBORAH A. GADOR, P.O. BOX 4133, GANEL TIKVA, 55900, IL

(21) Appl. No.: 12/365,917

(22) Filed: Feb. 5, 2009

(51) Int. Cl. G09B 19/06; G09B 5/00; G09B 19/00

(52) U.S. Cl. 434/157; 434/169; 434/167; 434/236

(57) ABSTRACT

The present invention relates to a method of teaching a foreign language by applying emotional intelligence tools. The method comprises the following steps: selecting a subject, selecting one or more elements of the language to be learned as linguistic objectives, selecting one or more emotional intelligence objectives to be reached through the subject, and using the elements of the language to be learned by carrying out educational activity which includes identifying a positive gate, classifying words and phrases representing different attitudes, emotions, moods and approaches, and conducting one or more exercises for enhancing the selected emotional intelligence objectives, whereby attainment and assimilation of the foreign language objectives and emotional intelligence objectives are simultaneously and mutually facilitated.

### BACKGROUND OF THE INVENTION

In recent years important work has been made to discover the emotional qualities and abilities that further personal enhancement, and success in setting out and reaching specific goals, i.e. emotional intelligence.

The degree of emotional development of a person may be measured as EQ, the emotional intelligence being susceptible to educational influence. On the other hand, emotional intelligence attributes may be employed to enhance learning procedures and to increase motivation and achievement. US 2004009457 for example describes a method for assessing and developing emotional intelligence in early childhood.

The study of a foreign language presents important learning opportunities for enhancing emotional intelligence and mastering emotional capabilities. By creating situations where emotions, identification, leadership, compassion and similar emotional capabilities are put into focus, the use of the words and expressions to be mastered becomes more intensive and motivated, thus enabling better and deeper integration of new words, expressions and grammatical forms in the student's vocabulary.

Conventional methods for teaching a foreign language involve tedious memorizing of vocabulary and endless repetition of grammar exercises. Even where reading, conversation and other, more or less entertaining, activities are employed vocabulary as well as grammar need to be repeated time after time and the process is long, difficult and unattractive.

The prior art describes several inventions concerning methods for foreign language learning. All these methods are concerned with tools and devices facilitating learning such as bilingual doll U.S. Pat. No. 6,554,616; phonetic transliteration card display U.S. Pat. No. 6,890,180; activity platform for learning language over a network U.S. Pat. No. 6,741,833 automated language acquisition system U.S. Pat. No. 7,052,278; method and device for foreign language teaching by means of recordings U.S. Pat. No. 4,170,834 etc.

There is no mention in the prior art of a method that combines the developing of emotional intelligence and applying the tools of emotional intelligence to the study of a foreign language.

Therefore there is a need for a method that systematically employs emotional intelligence tools such as awareness, freedom of choice, personal integrity, empathy, interactive leadership, positive thinking etc. for the teaching and acquiring of a foreign language while at the same time it enhances the emotional intelligence quota through the language learning process.

### SUMMARY OF THE INVENTION

The inventive method involves: selecting a subject, selecting one or more elements of the language to be learned as linguistic objectives and selecting one or more emotional intelligence objectives to be reached through the subject and carrying out educational activity comprising the following steps:

Jointly with students identifying a negative gate and naming one or more hindering feelings, moods and attitudes, representing that gate, that obstruct the road to reaching the emotional intelligence and linguistic objectives and further identifying a positive gate and naming one or more feelings, moods and attitudes representing that gate that provide opportunities for changing oneself and developing ideas towards reaching the preselected objectives;

making students aware of the preferred ways for reaching the preselected objectives by classifying jointly with students further words representing opposite or different approaches to the specific subject into groups, possibly using one or more visual representations such as:
a. defining a pair of circles or columns that represent opposite or different approaches to the specific subject, an approach that hinders the objectives and an approach that furthers the same objectives;
b. defining one or more triangles to represent passive, imaginary, hindering concepts as opposed to active, “working” positive attitudes that help advancing towards the objective by attaching the relevant words to the triangles;
c. defining a continuity line with a “neutral” point, a “reverse” point and a “drive” point for representing desirable actions, driving toward the objective and undesirable actions, leading away from the objective;
and conducting exercises that enhance the selected emotional intelligence objectives by encouraging productive, active and desirable approaches, attitudes and actions through application of linguistic elements such that attainment and assimilation of the foreign language objectives and emotional intelligence objectives are simultaneously and mutually facilitated.

### BRIEF DESCRIPTION OF THE DRAWINGS

FIG. 1 is a general schematic representation of the inventive method

FIG. 2 is a schematic representation of a pair of triangles for grouping different feelings and attitudes

FIG. 3 is a schematic representation of a pair of circles for grouping different feelings and attitudes

FIG. 4 is a schematic representation of a continuity line for representing advancing versus hindering attitudes

FIG. 5 is a schematic representation of a pair of circles for representing positive and negative approach to managing situations

### DETAILED DESCRIPTION OF THE INVENTION

The present invention offers a new method for the teaching of a foreign language that is designed to make a considerable contribution to reducing the level of violence in society, promoting personal improvement of members of society, enhancing interaction and mutual understanding between individuals, while using the language as a means of communication that is also a means of creating awareness such that awareness is taught via the foreign language and at the same time the foreign language is assimilated by using awareness along with other emotional intelligence tools, emotional intelligence (Eq) being the basic tool for assimilation of the foreign language.

The proposed method has the advantage of reducing the time required for mastering the foreign language while creating a unique combination of awareness and language capabilities.

The inventive method is meaningful, novel and fascinating in that it encompasses through a comprehensive approach the feeling and understanding of the student on a systemic level: on the level of the body, the mind, the feelings, the senses, the imagination, and awareness such that the acquired capabilities become an integral, unforgettable part of the student's personality.

Information and capabilities are transferred and acquired on an emotional experience interactive level such that activation of the intuitive/emotional intelligence is enhanced in a powerful manner and the linguistic materials find their way to the students' heart through the meaningful experience created by emotional intelligence tools.

Through the teaching of awareness by foreign language, young students may be directed as from an early age to connect to their inner selves and choose positive goals on which they may concentrate in their future activities. Through inner peace of the child a place of inner whole being is enabled. Through studying the language, students learn to identify and become aware of their capabilities, qualities and potential while they are assisted in development towards attaining their best selves by the instilment of emotional intelligence skills for reaching goals on their own.

The inventive method is easily adapted for the development of emotional intelligence skills in adults through the study of a foreign language as well as for the simultaneous facilitation of language assimilation through activating the student's emotional attributes.

The fundamental concept of the educational program in which the inventive method is applied is the establishment of a new idea—the foundation of a society based on joint leadership, that regards each individual as a potential leader of his surroundings, challenging him to contribute the best of his abilities, his capability of leadership and make a unique contribution such that each individual will enhance the surrounding members of society. When joint leadership subsists in its enhanced form, it offers a partnership that provides enhancement and has the power to eliminate the strife for power and control. This development is enabled by understanding how one was functioning in the past as an individual in various environments and in relation to oneself, what was the reason that the individual related to himself in that manner and what routes of action is it possible and necessary to follow in the future.

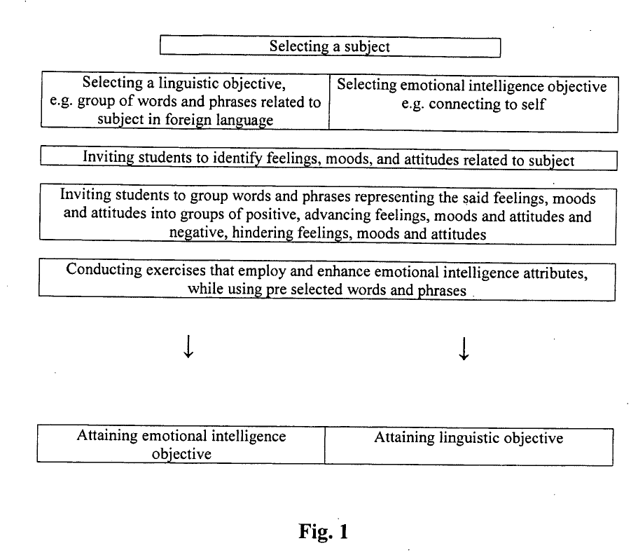

As shown in the schematic drawing of FIG. 1, the method of teaching a foreign language by applying emotional intelligence tools comprises the following steps: selecting a subject, selecting one or more elements of the language to be learned as linguistic objectives and selecting one or more emotional intelligence objectives to be reached through the subject and using the said elements of the language to be learned while carrying out educational activity that involves identifying positive and negative feelings, moods and attitudes and carrying out exercises enhancing positive emotional intelligence attributes whereby attainment and assimilation of the foreign language objectives and emotional intelligence objectives are simultaneously and mutually facilitated

In a more detailed form the inventive method may be described as involving: selecting a subject, selecting one or more elements of the language to be learned as linguistic objectives and selecting one or more emotional intelligence objectives to be reached through the subject and carrying out educational activity comprising the following steps:

Jointly with students identifying a negative gate and naming one or more hindering feelings, moods and attitudes, representing that gate, that obstruct the road to reaching the emotional intelligence and linguistic objectives and further identifying a positive gate and naming one or more feelings, moods and attitudes representing that gate that provide opportunities for changing oneself and developing ideas towards reaching the preselected objectives;

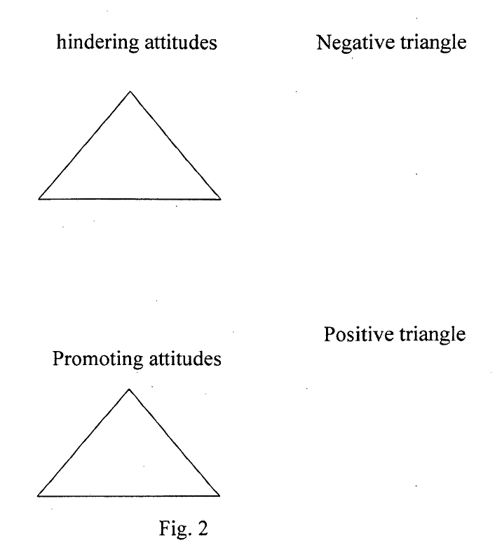

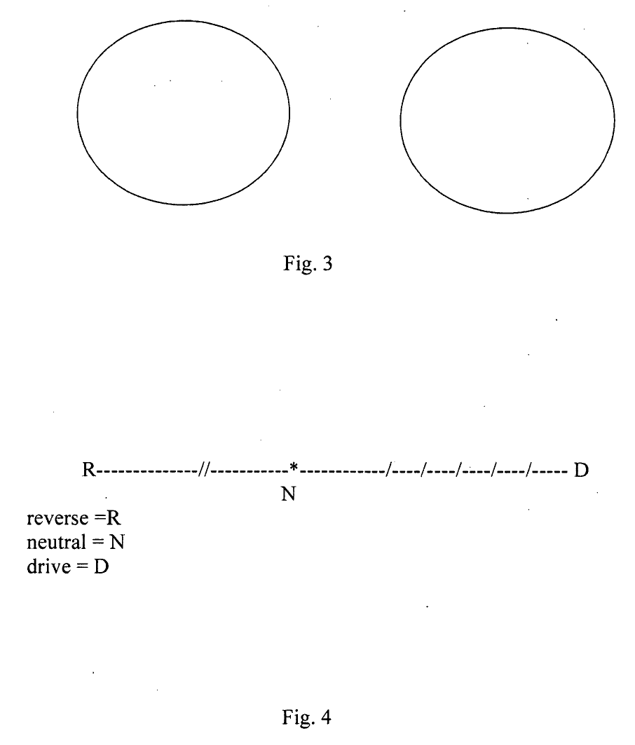

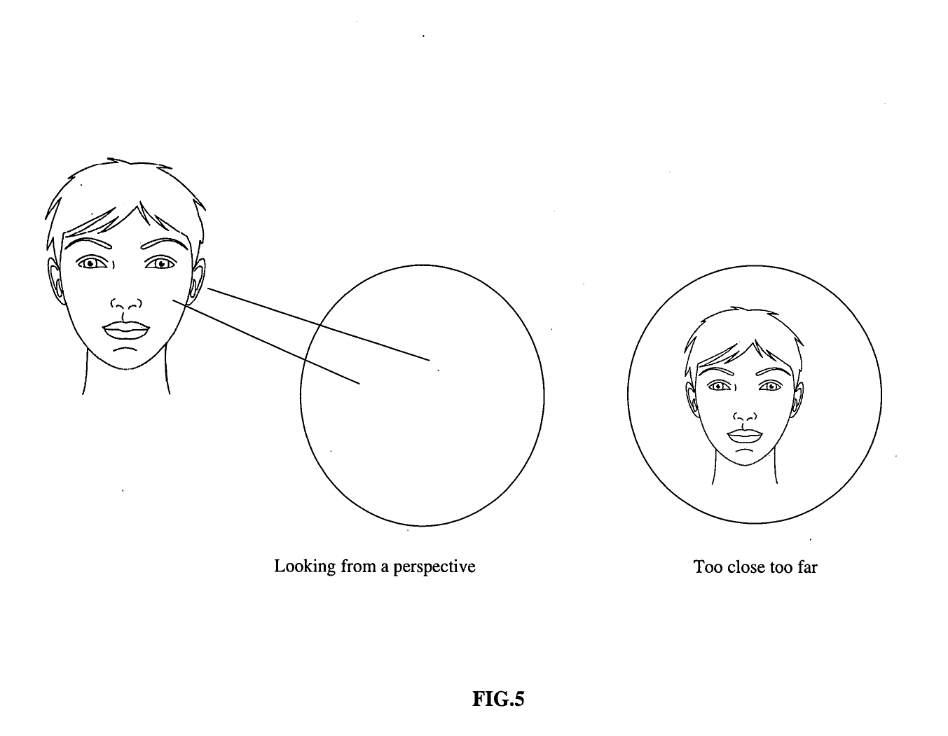

making students aware of the preferred ways for reaching the preselected objectives by classifying jointly with students further words representing opposite or different approaches to the specific subject into groups, possibly using one or more visual representations, some of which are shown in FIGS. 2-4 such as:
a. defining a pair of circles (shown in FIG. 3) or columns that represent opposite or different approaches to the specific subject, an approach that hinders the objectives and an approach that furthers the same objectives;
b. defining one or more triangles to represent passive, imaginary, hindering concepts as opposed to active, “working” positive attitudes that help advancing towards the objective by attaching the relevant words to the triangles (shown in FIG. 2);
c. defining a continuity line with a “neutral” point, a “reverse” point and a “drive” point for representing desirable actions, driving toward the objective and undesirable actions, leading away from the objective (shown in FIG. 3);
and conducting exercises that enhance the selected emotional intelligence objectives by encouraging productive, active and desirable approaches, attitudes and actions through application of linguistic elements such that attainment and assimilation of the foreign language objectives and emotional intelligence objectives are simultaneously and mutually facilitated.

It will be understood that the educational activity in accordance with the inventive method is not limited to a specific duration of time and it may be performed as part of a lesson, as a single lesson of any length or a series of lessons of any length of time that is deemed suitable for the specific activity.

Exercises comprise occupation with accessories for demonstration and figurative illustration and activating accessories such as cards, “set of four” cards, index cards, games, memory games, or activities such as drawing, discussion, guided imagination, physical activity, acting etc.

In the case of very young students, educational activities and exercises may be based on the senses such as caressing a dog or a cat, wrapping oneself in a quilt, hugging a teddy bear, tasting and smelling, embraces of parents and grandparents, holding hands with one's best friend, touching water, playing football/basketball, smelling the first rain, bathing in pool, sea or bath, tracing a smell or a sound, observing animal behaviour, comparing and identifying with desirable characteristics.

More negative sensations may also be discussed such as wet shoes, cold wind, touching a hedgehog, bitter taste etc.

Linguistic elements applied during educational activity and exercises include words, phrases, questions, answers, proverbs, stories with moral and similar elements of the language to be learned.

The learning process in accordance with the inventive method may be preceded or closed by a healing session or meditation or guided imagination or any similar means of mental preparation or relaxation.

In accordance with the basic approach of the inventive method, the guidelines for the learning process are:

Experiencing the words or phrases
Activating imagination
Discriminating between imagination and reality
Allowing room for instincts and intuition
Creating motivation for language learning through personal experience
Creating ongoing motivation for improvement of “self” and surroundings

Linguistic objectives comprise words, rules of grammar and various subjects in the language to be learnt such as colors, body parts, animals, feelings, the weather, literature, foods etc.

Emotional intelligence objectives can be selected from the group consisting developing and enhancing qualities and capabilities such as connecting to inner self, freedom of choice, permanent change, integrity, communication, joint leadership, feelings management, breakthrough, paradigms, friendship, relationships, clearing blocks from the past and creating new reality.

It will be understood that both language study and developing of emotional intelligence are educational activities that cannot be strictly confined to preset results such that while conducting educational activities aimed at developing a sense of inner self, other emotional intelligence attributes such as leadership may develop incidentally and while aiming at teaching the parts of the body, colors and other adjectives may also be assimilated.

The invention will be described herein below in detail and in accordance with examples that are to be regarded as non limiting preferred embodiments. It will be understood that many other ways and means of performing the inventive method are envisaged without exceeding the scope of the invention as defined and claimed in the claims.

### EXAMPLE I

In this example the pre selected linguistic objective is mastering a set of words in the language to be learnt and the emotional intelligence objective is enhancing inter alia the capabilities of connecting to inner self, calculating response and the awareness that words and ideas alone do not last and they must be accompanied by actions to be realized and assimilated.

As seen in FIG. 1, that is a schematic representation of one example of applying the inventive teaching method, the learning process may start by presenting the subject before the students through writing down the vocabulary to be mastered both on the blackboard and on students' worksheets and discussing the students' personal attitudes towards the subject, setting out the goals and prompting the students to invoke and express their qualities and potentials as the means of reaching the goals. The intention to realize the goals is a positive gate under which the activity will be conducted.

In according with this example, the learning process continues by introducing a text relating to the subject to be studied such as a story, an illustration or a proverb. Students are encouraged to express their ideas, feelings, attitudes and opinions regarding the subject and the list of words may be enlarged by those used to describe the said ideas, feelings, attitudes and opinions, in the students' first language as well as in the language to be learned.

The words are then classified in two circles that represent opposites—positive and negative or simply words that differ. The new words are presented along lines outwardly radiating from the circles.

It will be understood that a single circle or more than two or alternatively one or more columns may be used to classify the words

Next a “non existing triangle” is employed to regroup the words by presenting passive and negative concepts—beliefs, thoughts, feelings, relationships such as parent—child, teacher—student, that hinder and weaken. Yet another triangle is employed to represent positive and active states of mind such as inner confidence, things that can be overcome, beliefs needed for moving forward.

It will be understood that a single triangle or more than two triangles or alternatively one or more columns may be used to regroup the words

Each of the sides of a triangle is allotted a theme and each of the new words is attached to the side that represents the theme relevant to the specific word.

Through this activity, linguistic objectives such as stative verbs, generally expressing feelings, thoughts, senses or actions, may be mastered while at the same time students are prompted to become aware of the feelings they identify with and make decisions to adopt desirable attitudes or reject undesirable ones.

Thus students learn to be aware of their attitudes and be authentic, accepting the responsibility for their choices and for the results and outcome of having taken those choices.

Connecting to one's feelings creates a feeling of “being present”, of being and experiencing, while this activity also makes students aware of the distinction between their “doing” and their “being”.

In a subsequent phase of the learning activity, students are assisted in assimilating the language to be learnt by evoking imagination through feeling and intuition.

The students are required to close their eyes and connect to words in the language to be learnt chosen from the worksheet. Students are directed to questions such as “How do I feel with the word?”; “Is it fortifying and enhancing or is it rather weakening?”; “In which part of the body do I sense this word?”; “Which color seems to be associated with this word?” etc. whereby students are assisted in developing the capability of being connected as well as the capability of being accurate and discriminating with regard to their feelings and the relation between those feelings and their body.

Through this activity students will connect to their inner selves and by connecting reach the sense of “being” and “being present”.

The above described phase may be replaced or it may be followed by exercises employing one or more means for application of linguistic elements such as interactive memory games, playing games such as covering one's eyes and following one's senses, cards, “sets of four” cards, demonstration means, “bingo”, worksheets, coloring sheets, and physical activity.

Additionally or alternatively students may be required to choose an animal card or toy or an illustration of an animal with characteristics that are well suited to the subject under study, to choose words from the worksheet or blackboard and present them in personal “triangles”, cards, pictures or to work with personal index cards or pictures for each subject.

The activities and exercises are dynamic and suited to the students' age and level. It will be understood that text and vocabulary applied in this example may be adapted to different age groups, including adults and adolescents.

In a subsequent phase students are required to use continuity lines for indicating their position with relation to the objective, the point they wish to reach, the stages they need to pass or steps they need to take or the obstacles they need to overcome in order to approach nearer to their goal.

Finally students are assigned homework wherein words chosen for individual triangles during the lesson by each student are attached to a board in his room such that he may test his relationship to them during the interval before the nearest lesson and possibly apply them in practice. Students are further required to write short sentences or a description (according to age) in the language to be learned. These activities result in learning a. not to respond automatically b. words and ideas alone do not last and they must be accompanied by actions to be realized and assimilated. The educational activity is ended by healing or meditation.

### EXAMPLE II

The following is a description of a further example of a learning process in accordance with the invention that demonstrates the application of the inventive method to the linguistic objective of teaching the parts of the human body and a number of emotional intelligence objectives. This lesson is adapted to pupils of a very young age group. It will be understood however that the same method may be applied to reaching the same objectives with a group of adults, adolescents etc. by using different means, suitable to the specific age group in issue.

In a first step, the linguistic objective, namely mastering the names of human body parts, and the emotional intelligence objective, namely developing and enhancing the attributes and capabilities of “connecting”, “inward attention”, “awareness” and “confidence” are selected. The objectives are introduced to the students through a doll, pictures, stickers, drawings of a body or of faces with different expressions.

In a second step, a simple visual representation such as a gate marked “what makes me happy?” or “what makes me feel good?” (pleasant gate) is put before the students, by posting a drawing on the wall during the educational activity. An “unpleasant gate” may also be presented. At such early age, the gates are explained by discussing “what makes me feel happy”, “what makes me feel unhappy”, “what makes me feel sad, bored, shy, angry, love, excited; what makes me like something etc. . . . ” Naturally students may express negative as well as positive feelings but it is a basic principle of the inventive method that positive thinking is encouraged and the learning process is directed towards the development of positive attitudes.

A short session of mini meditation then follows, in which students are told to close their eyes, think about a sensation and locate this sensation in a part of the body. Students are asked questions such as “What do you feel?”; “In what part of the body?”; thus applying and assimilating the linguistic objective of parts of the body and possibly rehearsing past study of “colors” or “feelings” while at the same time enhancing the emotional intelligence objectives of connecting to inner self, awareness, interaction and confidence.

Students may be presented a pair of circles, one with a smiling face, expressing “pleasant” and the other with a face expressing “unpleasant”. A set of cards with different subjects such as animals, colors, expressions etc. are then used for prompting the students to group their favorite subjects around the “pleasant” circle and subjects they dislike—around the “unpleasant” circle.

Various exercises may then follow such as exercises concentrating on different parts of the body, pointing to other students' hands, legs etc., dancing, drawing or coloring drawings and playing with learning accessories such as cards to be assembled in series of four, memory cards containing words to be mastered that match drawings in other cards, flash cards, building blocks with complementary drawings to be matched, drawings of the body and of facial expressions etc.

Exercises may include flashing cards that show different expressions and asking students to name those expressions, putting cards with face down and trying to find matching opposites such as happy-unhappy, glad-sad, excited-bored, etc.

Cards with drawings of different situations, colors, foods etc. may also be classified into “what makes me happy” and “what makes me unhappy” groups.

Further exercises may include a song that chants the parts of the body. In according with the double objectives of the inventive method, this exercise will on the parts of the body that represent the seven basic centers of energy and on the colors of these centers of energy also known as chakras, namely head, forehead, neck, chest and upper and lower belly and the base chakra.

Exercises may further include following instructions such as “touch Roy's head”, “touch Shir's ears”, etc. Each student is asked to give similar instructions to the group. Such activities enhance communication, choice, involvement, belonging to a group.

A separate part of the lesson or another lesson may be dedicated to guided imagination exercises such as “let's walk inside our body with eyes closed”. An exercise according to the inventive method may comprise instructions and questions such as: “close your eyes, let's go to sleep”; “put your face to sleep, put your belly to sleep” and so on enumerating different parts of the body; “Now let's feel the feelings in our body”; “where in your body do you feel happy?”, “what color is this feeling?” “what makes you scared?” “where?” “let's make it smaller and smaller and smaller until it's gone”. It will be understood that such exercises lead towards the pre selected emotional intelligence objectives while at the same time furthering the pre selected linguistic objectives. It will be further understood that such exercises are especially suitable for ending a lesson in accordance with the inventive method, though they may be introduced at any suitable time during a lesson or a series of lessons.

Students may then be asked to “color their feelings” regarding parts of the body and compare them with previous colorings of parts of the body kept for this purpose by the teacher. It will be understood that in many cases parts of the body will now be colored differently.

As part of the educational activity, students may be assigned homework suitable for their age group such as climbing on a chair, taking an article off the shelf, running etc. so as to report what their sensations and feelings were and in which part of the body.

Students may also be asked to post the colored drawings on the wall in their room so that they will be reminded during the time until the next lesson of their connecting to themselves and their feelings and sensations.

Another kind of home assignment may be cutting photographs out of favorite newspapers to create a collage or making a drawing relevant to the subject.

The lesson may terminate with a relaxing exercise during which students lie down, shut their eyes and “put to sleep” and or “illuminate” parts of the body one by one

In according with another embodiment of the inventive method, after the relaxing exercise students may be asked to repeat the exercise of coloring parts of the body, in which case they may find that the colors they choose are different from the ones chosen at the first time.

It will be understood that through the above described educational activities, exercises and learning accessories, a parallel and simultaneous enhancement of the students' EQ attributes as well as better mastery of the language to be learnt are achieved.

It will be further understood that in a subsequent lesson the linguistic objective may be expanded by choosing related objectives such as verbs and further emotional intelligence objectives such as developing imagination may be added and achieved by applying further exercises such as reciting verbs with closed eyes and relating them to parts of the body. Some examples of such an exercise are; singing—throat, kicking a ball/jumping/dancing—feet, clapping/touching—hands, sleeping/seeing—eyes, eating/talking—mouth etc.

### EXAMPLE III

The following is a non limiting example of a lesson for grownup students in accordance with the invention.

The subject selected for the lesson is communication with oneself and with others.

The emotional intelligence objective selected for this lesson may be defined as getting in contact with our feelings by managing a situation.

The linguistic objective selected for the lesson is a vocabulary comprising:
a. a list of words describing a variety of feelings comprising modesty, compassion, generosity, warm feelings, calm, suffer, loved, confident, angry, frustrated, jealous, rejected, responsible, winner, self-centered, confused, authentic
b. a list of verbs comprising blame, accuse, struggle, communicate, complain, express, justify, judge, recognize, activated, control, manipulate
c. a list of nouns, comprising awareness, position, power, result, benefit, advantage, responsibility, integrity, victim, fear, self esteem, greed, manipulation, disagreement, argument

The subject is presented to the students by raising questions such as “what is communication?” allowing them to propose a list of TV, radio, newspapers and people, me etc.

Another question may be “do we listen or do we hear” and students will be led to the idea that “hear” and “see” are performed by our senses whereas “listen” and “look” are by our intuition.

Students are confronted with the idea that in order to communicate with ourselves we should listen and look; that we are often activated by different situations in life and quite often we are not aware of our feelings involved, that by looking at those feelings and recognizing them we can manage and control them instead of being activated and manipulated by our emotions, that some emotions are positive and others are obstacles on our way to achieve peace and happiness.

The subject is further presented to the students by visually describing the two situations as a first circle with a person inside and a second circle with a person outside it. The said circles are shown in FIG. 5.

The first circle is entitled “too close too far” and characterized as
1. I am in the situation
2. I am the situation
3. If the situation is a problem—I equal a problem
4. acting emotionally

The second circle is entitled “looking from a perspective” and characterized as
1. I look at the situation
2. I am not the situation
3. I am not the problem
4. acting rationally
As one educational activity discussion of our feelings follows, during which students are asked to sort the feelings discussed to the above detailed circles and to add more feelings and related verbs, adjectives or nouns of their own.
Next students are introduced to accepting responsibility for their feelings, looking at them and acknowledging them in a manner that enables them to manage the said feelings.
As a further educational activity, each student chooses a personal situation to work on and figure out the hindering emotional elements of the situation, the solutions and the feelings and behavior that lead to the solution. Students are asked to represent the elements of their situation according to a triangular scheme where one tip of the triangle indicates “acknowledgement—thoughts/feelings/beliefs/facts”, a second tip of the triangle indicates “what do I really need/feel—authentic feeling” and a third tip indicates “what should I have/do to relax or heal this need”.
Exercises then follow, such as using cards that represent positive qualities only.

These exercises help the student to be tuned and focused towards self improvement.

In the course of a lesson for adults according to the inventive method a session of meditation may be included, preferably towards the end of the lesson. Where a series of lessons are involved, different or similar meditation sessions may be applied in different lessons, such as in the following, non limiting, examples:
a.
   a. Students are asked to choose a number of words expressing qualities that assist self improvement. Next students are instructed to close their eyes and take several deep breaths, to think of the chosen words and imagine them one by one by feeling them in his body, connecting intuitively to the specific chosen words. Students are instructed to contemplate: How do I feel with the word? Is it empowering or weakening me? In which part of my body do I sense this word? Students are guided during meditation with intervals in between and the session is ended by telling students to conclude their meditation and slowly feel the physical surroundings.

### Or

b. Negative feelings are dealt with through meditation by observing them and placing them inside the body, describing the texture, shape and color of this feeling, dissolving, melting and illuminating the place such that relaxation gives the opportunity to re-consider attitudes.

### Or

c. Preparing for healing a relationship, connecting with another through a positive route. Students are asked to take a few slow deep breaths. After a while they are asked to imagine the person they want to work with, solve something, or ask for forgiveness before meeting him, or imagine any problem they wants to solve, to imagine the situation and its positive result. The teacher is silent for a while, music is sounded. Then students are asked to start coming back to here and now, slowly. It will be understood that this kind of meditation may work for more than one person involved.

The inventive method for developing EQ while teaching a foreign language and teaching a foreign language through EQ is suitable for primary and high school curriculums as well as for nursing schools, colleges and academic institutions.

It will be understood that the teaching method in accordance with the invention may be developed into one or more teachers' or students' guides or workbooks or textbooks and it may be additionally or alternatively recorded on digital or analog media. It will be further understood that the inventive method may be broadcast as a TV series.

1. A method of teaching a foreign language by applying emotional intelligence tools comprising the following steps:
a. selecting a subject
b. selecting one or more elements of the language to be learned as linguistic objectives and selecting one or more emotional intelligence objectives to be reached through the subject
and
c. using the said elements of the language to be learned, carrying out educational activity comprising:
(a) identifying a positive gate
(b) classifying words and phrases representing different attitudes, emotions, moods and approaches
(c) conducting one or more exercises for enhancing the selected emotional intelligence objectives
whereby attainment and assimilation of the foreign language objectives and emotional intelligence objectives are simultaneously and mutually facilitated.

2. A method of teaching a foreign language by applying emotional intelligence tools according to claim 1 wherein the said educational activity further comprises meditation.

3. A method of teaching a foreign language by applying emotional intelligence tools according to claim 1 wherein the said subject is selected from the group consisting of a story, a poem, and a song.

4. A method of teaching a foreign language by applying emotional intelligence tools according to claim 1 wherein the said elements of the language to be learned are is selected from the group consisting of a list of words, a list of phrases and rules of grammar.

5. A method of teaching a foreign language by applying emotional intelligence tools according to claim 1 wherein the said emotional intelligence objectives are selected from the group consisting of freedom of choice, personal integrity, empathy, interactive leadership, positive thinking and problem management.

6. A method of teaching a foreign language by applying emotional intelligence tools according to claim 1 wherein the said words and phrases representing different attitudes, emotions, moods and approaches are classified with the aid of one or more geometrical shapes.

7. A method of teaching a foreign language by applying emotional intelligence tools according to claim 1 wherein the said words and phrases representing different attitudes, emotions, moods and approaches are classified such that they are attached to one or more circles.

8. A method of teaching a foreign language by applying emotional intelligence tools according to claim 1 wherein the said circles are assigned different characteristics.

9. A method of teaching a foreign language by applying emotional intelligence tools according to claim 1 wherein the said different characteristics assigned to the said circles are “hindering attitudes” and “promoting attitudes”.

10. A method of teaching a foreign language by applying emotional intelligence tools according to claim 1 wherein the said words and phrases representing different attitudes, emotions, moods and approaches are classified such that they are attached to the tips of one or more triangles.

11. A method of teaching a foreign language by applying emotional intelligence tools according to claim 1 wherein the said triangles are assigned different characteristics.

12. A method of teaching a foreign language by applying emotional intelligence tools according to claim 1 wherein the said different characteristics assigned to the said triangles are “positive approach” and “negative approach”.

13. A method of teaching a foreign language by applying emotional intelligence tools according to claim 1 wherein the said words and phrases representing different attitudes, emotions, moods and approaches are classified such that they are presented along a continuity line.

14. A method of teaching a foreign language by applying emotional intelligence tools according to claim 1 wherein the said continuity line has opposite “drive” and “reverse” ends with a “neutral” point between them and the said words and phrases representing different attitudes, emotions, moods and approaches are listed along the continuity line in accordance with their characteristics as promoting or hindering.

15. A method of teaching a foreign language by applying emotional intelligence tools according to claim 1 wherein the said exercises are selected from the group consisting of occupation with accessories for demonstration and figurative illustration such as cards, “set of four” cards, index cards, and games, artistic activities such as drawing and coloring, physical activity, activity based on the senses, guided imagination, concentration on the parts of the body that represent the seven basic centers of energy and on the colors of these centers of energy also known as chakras.

16. A method of teaching a foreign language by applying emotional intelligence tools according to claim 1 that is adapted for persons selected from the group consisting of young children and adults.

17. A method of teaching a foreign language by applying emotional intelligence tools according to claim 1 that is adapted as a TV series.

18. A method of teaching a foreign language by applying emotional intelligence tools according to claim 1 that is recorded on media.

19. A method of teaching a foreign language by applying emotional intelligence tools according to claim 1 that is described in a book.

20. A method of teaching a foreign language by applying emotional intelligence tools according to claim 1 that is applied in a workbook.
